(19) United States
(12) Patent Application Publication
(10) Pub. No.: US 2011/0019914 A1
(43) Pub. Date: Jan. 27, 2011

(54) METHOD AND ILLUMINATION DEVICE FOR OPTICAL CONTRAST ENHANCEMENT

(76) Inventors: Oliver BIMBER, Giesson (DE); Daisuke Iwai, Osaka (JP)

Correspondence Address: Muncy, Geissler, Olds & Lowe, PLLC, 4000 Legato Road, Suite 310, FAIRFAX, VA, 22033, US

(21) Appl. No.: 12/895,111

(22) Filed: Sep. 30, 2010

Related U.S. Application Data
(63) Continuation of application No. PCT/EP2009/053549, filed on Mar. 25, 2009.

(30) Foreign Application Priority Data
Apr. 1, 2008 (DE) 102008000906.7
Dec. 5, 2008 (DE) 102008060475.5

(51) Int. Cl. G06K 9/00; G06K 9/40; H04N 7/18

(52) U.S. Cl. 382/167; 382/274; 348/61; 348/65; 348/79; 348/E07.085

(57) ABSTRACT

A method and an illumination device is provided for optical contrast enhancement of an object through a spatially and/or temporally modulated illumination of the object by way of at least one light projection unit, wherein the spatial and/or temporal modulation of the illumination of the object is determined using a set of image data associated with the object.

This nonprovisional application is a continuation of International Application No. PCT/EP2009/053549, which was filed on Mar. 25, 2009, and which claims priority to German Patent Application Nos. DE 102008000906.7, which was filed in Germany on Apr. 1, 2008, and DE 102008060475.5, which was filed in Germany on Dec. 5, 2008, and which are both herein incorporated by reference.

### BACKGROUND OF THE INVENTION

1. Field of the Invention

The invention relates to a method and an illumination device for optical contrast enhancement of an object.

In this context, optical contrast enhancement can be understood to mean an enhancement of visually perceptible and/or measurable optical contrasts.

2. Description of the Background Art

The display of images with a high contrast ratio, known as high dynamic range (HDR) images (with a bit depth greater than 8) may be recorded by appropriate HDR cameras or may be produced artificially, for example as three-dimensional computer graphics. To date, however, only few output devices exist that are capable of directly displaying HDR images. HDR images cannot be displayed directly on conventional output devices, but instead must be converted into low dynamic range (LDR) images by so-called tone-mapping techniques (dynamic compression techniques) in which the brightness contrasts of an HDR image are reduced.

A variety of approaches are already known for improving the display of HDR images with the aid of conventional display device, for example LDR displays (LDR screens).

In order to simplify the description here and hereinafter, the widespread convention is used of not distinguishing between an image and a data record describing an image, provided that the intended meaning of the term “image” can be inferred from context in each case.

It was only recently that displays for displaying HDR images were introduced that are capable of presenting content across an order of magnitude of several powers of ten between minimum and maximum luminance. For example, in P. LEDDA, et al., 2003, “A wide field, high dynamic range, stereographic viewer,” Proc. Conference on Computer Graphics and Interactive Techniques in Australasia and Southeast Asia, pp. 237-244, a passive, stereoscopic HDR viewer is described that uses two transparency films layered one on top of the other for each eye for luminance modulation, and achieves a contrast ratio of 10,000:1.

In H. SEETZEN et al., 2004, “High dynamic range display systems,” Proc. ACM Siggraph, pp. 760-768, active displays are described that modulate images which are displayed on a liquid-crystal display monitor (LCD panel) with a locally varying backlight. These images are produced either by a low resolution LED panel (LED=Light Emitting Diode), or by a high resolution DLP projector (DLP=Digital Light Processing), which is to say by a light projector with a matrix-like array of individually movable micromirrors for light projection. This paper reported a contrast ratio of over 50,000:1 together with a peak luminance of 2,700 cd/m² (for the projector-based backlight).

Numerous inverse tone-mapping techniques are currently under development (for example, F. BANTERLE et al., 2006, “Inverse tone mapping,” Proc. Conference on Computer Graphics and Interactive Techniques in Australasia and Southeast Asia, pp. 349-356) for converting existing LDR images into an HDR format that can be viewed on such devices.

All the approaches known from the above-mentioned publications are beset by the following disadvantages: Firstly, they use a transmissive image modulation (either through transparencies or LCD/LCoS panels, LCoS=Liquid Crystal on Silicon), consequently suffer from a relatively low light throughput and therefore require exceptionally bright backlights. Secondly, one of the two modulation images is of low resolution and blurred in order to avoid artifacts such as moiré patterns due to shifting of the two modulators relative to one another, and in order to realize acceptable frame rates. Accordingly, high contrast values can only be achieved in a resolution of the low-frequency image. Thirdly, since one of the two images is monochrome, only luminance is modulated.

Specialized printing methods that support filmless imaging are rich in possibilities for many medical applications and other fields. Compared to conventional hardcopy media, such as X-ray film for example, they offer significant cost reductions, better durability (due to reduced sensitivity to light), and color visualization. They provide virtually diagnostic quality, and have a much higher resolution than would be possible with most interactive displays, but they do not achieve the high contrast, luminance, and perceived tonal resolution of, e.g., X-ray film viewed with a light box.

In addition to the display of HDR images, the invention also concerns the contrast-enhancing display of ordinary (LDR) images and of other objects, in particular objects that are to be imaged with an optical instrument, for example with an optical microscope or endoscope.

From DE 196 44 662 C2, which corresponds to U.S. Pat. No. 6,243,197, is known a lighting device for a microscope which has a video projector for object illumination. The video projector has, for example, a liquid crystal cell, or is implemented as a so-called DLP projector. The video projector can be controlled through a computer to realize different illumination states of the object illumination.

### SUMMARY OF THE INVENTION

It is therefore an object of the invention is to provide an improved method and an improved device for optical contrast enhancement of an object, wherein the object may in particular be an image.

In the inventive method, optical contrasts of an object can be enhanced by a spatially and/or temporally modulated illumination of the object by means of at least one light projection unit. In this process, the spatial and/or temporal modulation of the illumination of the object is determined on the basis of an image data record associated with the object.

A light projection unit can be understood here to mean a projection unit by means of which electromagnetic radiation can be emitted. In this context, the term is not limited to electromagnetic radiation having wavelengths primarily in the visible range or having a spectrum similar to that of white light. Hence, it includes projection units that emit electromagnetic radiation having wavelengths not in the visible range and/or having a spectrum differing from that of white light.

In this regard, the invention makes use of the fact that optical contrasts of an object can be enhanced by modulated illumination of the object. Modulation using an image data record advantageously makes it possible to ascertain low-contrast areas of the object using the image data, and also to control a light projection unit using the image data, with the image data being processed for contrast enhancement. In this way, the inventive method implements a simple and economical method for contrast enhancement with inexpensive and widely available display devices. In particular, the method does not require costly output devices that are directly HDR-capable in order to display HDR images.

As a result of the modulated, contrast-enhancing illumination of the object, an optical signal-to-noise ratio, in particular, can be increased even before a recording or display of the object. Such an increase of the signal-to-noise ratio can be used to advantage, both in applications in which the object is viewed directly or by means of an optical instrument such as a microscope or endoscope, and in applications in which image processing is undertaken of an image that has been recorded of the object.

The illuminated object may be two-dimensional here, for example a printed image or an image displayed on a screen or projected onto a projection surface, or it may be a three-dimensional object, for example an object to be imaged by means of an optical instrument such as an optical microscope or endoscope.

The illumination of the object may be reflective, which is to say as incident illumination, and/or transmissive, which is to say as transmitted illumination, in its implementation. Transmissive illumination is suitable for sufficiently light-transmitting objects, for example for transparent X-ray images or objects to be examined using transmitted light microscopy. For such objects, it can be especially advantageous to carry out the method simultaneously with both reflective and transmissive illumination, for example with one light projection unit each for both incident illumination and transmitted illumination.

According to an embodiment, which is described in detail further below, both the object itself and the image data record are generated from a source image, which may exist as an HDR data record, in particular. As the object for this purpose, a first image is derived from the source image, and displayed using an image display device. The image data record is derived from the source image as a second image, which is projected congruently onto the first image to enhance its contrast. The first and second images each have a contrast range that is lower than the source image and lower than an overall image resulting from their superimposition.

In this process, the contrast ratio of the first image is limited by the contrast ratio displayable by the image display device. For example, the image display device is a printer with which the first image is printed out, or is so-called electronic paper, which is to say a special display for displaying documents, on which the first image is displayed. By projecting the second image onto the first image, the first image is advantageously modulated in a contrast-enhancing manner. In this way, the superimposition of the two images produces an overall image whose contrast ratio can significantly exceed the contrast ratio displayable by the image display device. Here, the first image can be, in particular, a reflectively displayed image, in other words an image that is perceived by light reflected therefrom.

This embodiment is especially useful for displaying HDR source images without costly HDR output devices, and thus offers an economical alternative for displaying HDR source images in areas that work with such source images, such as radiology and other medical fields, or astronomy. In particular, the method permits high-contrast display of HDR source images as hardcopies on photo paper, or using electronic paper, where the use of electronic paper also allows for interactive visualizations.

Experiments have demonstrated that it is possible here to achieve contrast ratios of over 45,000:1 with a peak luminance of more than 2,750 cd/m², and is technically possible to achieve more than 620 perceptually distinguishable tonal values. Moreover, it was possible to attain color space extensions of up to a factor of 1.4 as compared to a regular projection, or a factor of 3.3 as compared to regular hardcopy prints. As a result, the hardcopy resolution can be several thousand dpi, while luminance and chrominance are modulated with a registration error of less than 0.3 mm.

Another embodiment of the inventive method provides for the image data record that is used to derive the modulation of the illumination of the object to be created from a camera image of the object recorded by means of a camera. In this process, an illumination data record for controlling a light projection unit is produced from the image data record.

Thus, in this embodiment the image data record is not generated from an already existing source image, but instead from a camera image of the object recorded by means of a camera. Then an illumination data record is produced from the image data record; the light projection unit is controlled by means of the illumination data record for contrast-enhancing illumination of the object. In advantageous fashion, this permits contrast enhancement according to the invention even in cases where no source image, in particular no source HDR image, is available.

In this process, an intermediate image with an increased contrast ratio as compared to the camera image can be first formed from the image data record by means of inverse tone mapping, and then the illumination data record is generated from the intermediate image.

In this case, the intermediate image assumes the role of the source image from the first embodiment of the method. The illumination data record assumes the role of the second image from the first embodiment. In this way, the advantages of the first embodiment of the method can even be used in cases where no original (HDR) image is available.

The illumination data record can, in particular, be a second image of the object and be projected congruently onto the object.

In this context, the object may be an LDR image, for example an ordinary photograph, or it may be another object, for example a three-dimensional object to be imaged by means of an optical instrument such as an optical microscope or endoscope.

In an embodiment, local contrast values are derived from the image data record and contrasts are locally increased in areas of the object recognized as low-contrast by regulating the illumination characteristics of the at least one light projection unit using the illumination data record.

The illumination characteristics of a light projection unit here are understood to be the spatial and temporal intensity and spectral distribution of electromagnetic radiation emitted by the light projection unit.

The local increase in the contrasts is accomplished here by a local increase in the illumination intensity and/or a local change in the illumination color, for example. In this way, the quality of the reproduction of the object can be improved in low-contrast areas by contrast enhancement, and in particular by local contrast optimization. In particular, the contrast regulation can be adapted to human visual perception by a regulation of local contrasts that is adapted thereto, so that this regulation effects an increase in locally perceived contrasts.

Alternatively or in addition, image parameters can be derived from the image data record for the detection of highlights produced by light reflections at the object, and detected highlights are counteracted by the regulation of the illumination characteristics of the at least one light projection unit.

In this context, a highlight is understood to mean a specular (mirror-like) reflection of light from an area of the surface of the object. Suitable image parameters for detection of highlights are, for example, local brightnesses of the object.

In this regard, highlights are counteracted, for example, in that the illumination intensity is reduced in areas of the object in which highlights have been detected. In particular, the intensity can be reduced as a function of wavelength if the detected highlights have a specific color. For example, if a red highlight is detected in an area of the object, then the red component of the illumination is reduced in this area. In this way, the light intensity of highlights in the reproductions of the object, and thus a degradation of the quality of the reproduction, by highlights is advantageously reduced.

In another embodiment of the method, in addition or as an alternative, image parameters for detection of scatterings of the light emitted by the at least one light projection unit can be determined, and detected scatterings are counteracted by the regulation of the illumination characteristics of the at least one light projection unit.

In this context, scattering can be understood to mean the scattering of light that penetrates into the object and is scattered inside the object before it exits the object. Furthermore, scattering can include, for example, surface scattering, subsurface scattering, or volume scattering.

Scattering can considerably reduce the quality of the reproduction of an object, in particular the local contrasts of the reproduction, in that it distributes light within the object and thereby, in particular, counteracts a spatial and temporal modulation of the illumination characteristics of the at least one light projection unit. Thus, the detection and reduction of scattering increases the effectiveness of the modulation of the illumination characteristics and improves the quality of the reproduction of the object, especially with regard to its local contrasts.

Suitable image parameters for detecting scattering, depending on the specific properties of the object, include, for example, point spread functions, modulation transfer functions, or matrix elements of a light transport matrix of the illumination device, each of which is ascertained under repeated illumination of the object with different illumination patterns of the at least one light projection unit. In this context, a light transport matrix is understood to be a matrix that describes the so-called light transport between a light projection unit and the camera in that it produces a relationship between an illumination pattern transmitted by the light projection unit and the associated image data captured by the camera, c.f., for example, Sen et al., “Dual Photography,” ACM Trans. Graph. 24, 3, pp. 745-755.

Such image parameters are suitable for detecting scattering, since they permit the detection of a local distribution of point-transmitted light after its modulation by the object, which distribution is a function of scattering. In particular, the more scattering occurs, the greater the extent of such a distribution becomes. In this way, areas of the object in which increased scattering occurs can be identified by means of such image parameters.

Detected scattering can be counteracted, for example, in that an illumination intensity produced by a light projection unit is locally reduced in these areas. Furthermore, the illumination intensity can, in particular, be advantageously reduced in a wavelength-dependent manner when wavelength-dependent scattering is detected.

In this way, areas of the object in which increased scattering arises are illuminated less strongly, and if applicable in a wavelength-dependent manner, than other areas of the object, thus advantageously reducing scattering and its disadvantageous effects on the quality of the reproduction of the object.

In another embodiment of the method, image parameters for selecting at least one image segment of the reproduction of the object are determined. Through regulation of the illumination characteristics of the at least one light projection unit, at least one area of the object corresponding to at least one ascertained image segment is emphasized or masked by a local alteration of the illumination intensity and/or illumination color.

In this context, an area that is said to be masked is not illuminated or is illuminated significantly less strongly in comparison with other areas.

By means of emphasis, an especially interesting area of the object can advantageously be visually highlighted, so that a viewer of the reproduction of this object is directed to this area. By means of masking, non-relevant areas of the object can be hidden, and the viewer's attention can advantageously be drawn to the important areas of the object. For example, such emphasis or masking can be used advantageously in assistance systems in surgical operations in order to concentrate the choice of images on the areas of the object that are relevant for a particular operation.

In this context, the camera is preferably arranged in a beam path of the light emitted by the at least one light projection unit in such a manner that the camera receives light reflected by the object or transmitted through the object.

Light transmitted through the object is understood to mean light that passes through the object and that enters the object and exits from it in approximately the same direction.

An arrangement of the camera in which the camera receives light reflected from the object is preferred in those circumstances when the object is viewed through light reflected by the object, for example when the object is being viewed by means of an incident light microscope. Correspondingly, an arrangement of the camera in which it receives light transmitted through the object is preferred when the object is viewed by light transmitted through the object. As a result of such an arrangement of the camera that is matched to the viewing of the object, the image data record ascertained by means of the camera can be used especially advantageously for regulating the illumination characteristics of a light projection unit.

An inventive illumination device for optical contrast enhancement of an object includes at least one light projection unit whose illumination characteristics can be modulated spatially and/or temporally, and a control unit for modulating the illumination characteristics of the at least one light projection unit on the basis of an image data record associated with the object.

In advantageous fashion, this permits modulation of the illumination of the object in accordance with the inventive method with the abovementioned advantages.

The illumination device additionally includes a camera coupled to the control unit, by which means a camera image of the object can be recorded in order to create the image data record.

In advantageous fashion, this permits the above-described second embodiment of the inventive method to be carried out. Moreover, it is advantageously possible to use the camera to calibrate the at least one light projection unit.

In this context, the camera can be arranged in a beam path of the light emitted by the at least one light projection unit in such a manner that the camera receives light reflected by the object or transmitted through the object.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an illumination device for contrast-enhancing illumination of an object;

FIG. 2 schematically shows an illumination device for an optical microscope for incident light microscopy;

FIG. 3 shows an optical microscope with an illumination device for incident light microscopy;

FIG. 4 schematically shows spatially modulated incident illumination of an object to be examined by microscope;

FIG. 5 schematically shows an illumination device for an optical microscope for transmitted light microscopy;

FIG. 6 shows an optical microscope with an illumination device for transmitted light microscopy; and

FIG. 7 schematically shows spatially modulated transmitted modulation of an object to be examined by microscope.

### DETAILED DESCRIPTION

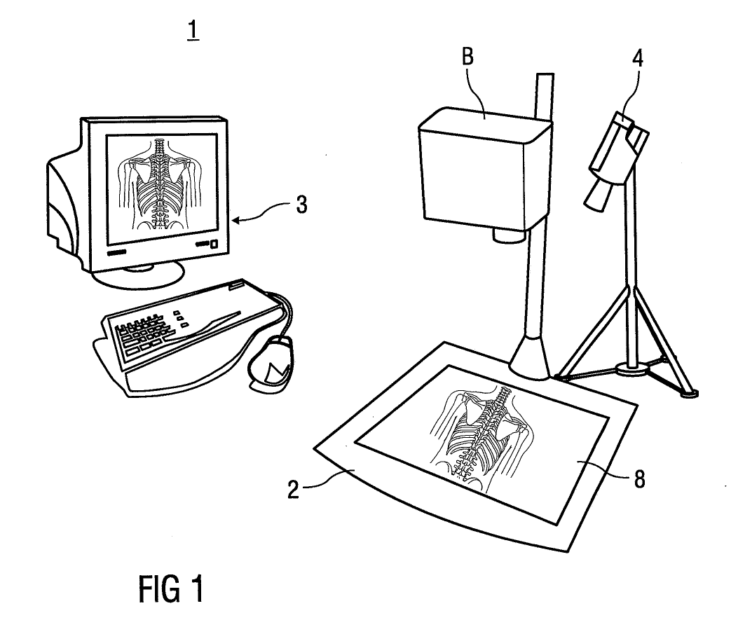

FIG. 1 shows an illumination device 1 for contrast-enhancing illumination of an object 8. The illumination device 1 includes a digital light projection unit B whose illumination characteristics can be modulated spatially and temporally, a control unit 3 for modulating the illumination characteristics of the one light projection unit B, and a digital camera 4.

The object 8 is a first image I_{A} printed on photo paper, which is mounted on a projection surface 2. The printout of the first image I_{A} is also referred to below as a hardcopy. A tray, which can optionally be tilted a little for specular photographs in order to direct highlights away from the observer, may be used as the projection surface 2. Alternatively, the first image I_{A} may be displayed on electronic paper, for example. This permits interactive content to be displayed, as well.

The light projection unit B can be implemented as, for example, a DLP or GLV (GLV=Grating Light Valve) projector and projects a second image I_{B} onto the first image I_{A} in order to modulate the latter for contrast enhancement. The light projection unit can also include other devices known to one skilled in the art, such as LCD or LCOS.

A camera image of the object is recorded using the camera 4. The illumination device 1 is initially calibrated with the aid of the camera image, with a registration of the images I_{A}, I_{B} being carried out.

The control unit 3 is implemented as a computer, and is used, in particular, as the means by which the light projection unit B is controlled, the camera image is evaluated, and the illumination device 1 is calibrated.

Geometric registration: A precise geometric registration between the light projection unit B and the first image I_{A} is essential, to ensure that its superimposition with the second image I_{B} does not result in display errors. Three automatic registration methods for different situations are described below.

Homography: First, a homography is measured between the camera 4 and the light projection unit B through the projection plane 2. The first image I_{A} is printed with a border that permits reliable detection of the corner points of the first image I_{A} in the camera perspective. A homography matrix, together with the corner points, permits a transformation of all camera pixels into the perspective of the light projection unit B and its precise registration to the corresponding pixels of the first image I_{A}. For effective homography, the hardcopy must be completely planar. This is achieved in that it is clamped flat on the projection surface 2, or through the use of professional vacuum tables.

The printed border and the prerequisite planarity of the hardcopy present limitations that can only be met by some applications, while others require more flexibility. Images that are printed on photographic paper are normally never totally flat. Furthermore, portions of an original image may be cut off during a reformatting process of a printer, with image areas at the edge not appearing on the hardcopy. In such cases, a simple registration via homography and corner points may be insufficient. Assuming that the hardcopy is of arbitrary shape but contains no geometric irregularities (but possibly radiographic ones), the registration technique described below can be applied.

Structured light: Techniques with structured light (e.g., what are known as Gray codes) can be used to measure pixel correspondences between the camera 4 and the light projection unit B over a non-planar hardcopy surface. However, this must be robust for nonuniformly colored and dark surface portions that absorb a large proportion of the projected light. Moreover, a method that requires the recording of as small a number of images as possible for the registration is advantageous, both to accelerate the registration process and to prevent overstressing of mechanical parts, particularly if the camera 4 is designed as a digital single-lens reflex camera, for example.

A preferred procedure requires the recording of only three images. Two of these images represent horizontal and vertical grid lines and a color-coded absolute reference point in the center of the grid. The third image is a white-light image of the hardcopy, which is recorded by the camera 4 under projected white-light illumination. The two grid images are divided by the white-light image for normalization, and the results are compared to a threshold value and binarized. The lines and the reference point are reconstructed by labeling and line-following, and intersections between connected line segments are detected. The intersections are triangulated relative to the absolute coordinates of the reference point, and projector/camera correspondences of the camera 4 and the light projection unit B that are located between them are interpolated. In this process, the precision of this technique depends primarily on the adapted grid resolution and the degree of curvature of the hardcopy.

For the above-mentioned registration methods “homography” and “structured light,” registration errors are normally below 0.3 mm.

So-called feature points are detected in the recorded camera image of the hardcopy, and are associated with image features of the first image I_{A} (details of this can be found in V. LEPETIT et al., 2006, “Keypoint recognition using randomized trees,” IEEE Trans. On Pattern Analysis Machine Intelligence 28, 9, pp. 1465-1479). All associated feature points are triangulated, and missing correspondences inside and outside the convex envelope of the constructed triangulation network are interpolated or extrapolated. A resulting lookup table provide pixel correspondences between the hardcopy and the first image I_{A}, which can be used in combination with the projector/camera correspondences (ascertained either through homography and corner points or through structured light) to place pixels of the light projection unit B in connection to the corresponding pixels of the first image I_{A}. The precision of such feature-based registration techniques depends very strongly on the number and distribution of the detected feature points, and thus on the image content.

Coaxial alignment of the camera 4 and the light projection unit B: A coaxial alignment of the camera 4 and the light projection unit B simplifies the registration, since no pixel correspondences need be ascertained between the camera 4 and the light projection unit B.

Photometric calibration: Regardless of the registration method used, implementing the invention described here requires the linearized transfer functions of the light projection unit B and the camera 4, which are ascertained for each equipment setup through a photometric calibration. The camera 4 is calibrated, for example with a spectroradiometer, in order to provide correct luminance and chrominance values. In addition, the nonlinear light loss and the contribution of the environment (including the black level of the light projection unit B) on the projection surface 2, as well as the color channel mixing occurring between the camera 4 and the light projection unit B, must be measured and compensated for all projected and recorded images. In order to accomplish this, established techniques for photometric calibration of projector/camera systems can be used. Details of these techniques are summarized in M. BROWN et al., 2005, “Camera Based Calibration Techniques for Seamless Multi-Projector Displays,” IEEE Trans. on Visualization and Computer Graphics 11, 2, pp. 193-5 206; and in O. BIMBER et al., 2007, “The Visual Computing of Projector-Camera Systems,” Proc. Eurographics (State-of-the-Art Report), pp. 23-46. If a light projection unit B with pulse modulation is used, the frame rate of the projection must always be an integer multiple of the exposure time of the camera 4 to ensure correct integration over all colors and intensities. For display purposes, however, any desired frame rate can be chosen. Information on photometric correction of hardcopy devices is described in the sections that follow, together with individual rendering techniques.

Splitting a source image I_{HDR}: As already described in brief above, in a first embodiment of the inventive method the first image I_{A} and the second image I_{B} are obtained from a source image I_{HDR}. This generation of the images I_{A}, I_{B} is also referred to below as splitting of the source image I_{HDR}. Especially when the source image I_{HDR} is present in the form of an HDR data record, the two images I_{A}, I_{B} are preferably generated from the source image I_{HDR} in accordance with the following calculation rule:

$$\begin{matrix}{I}_{A} = {{TM}_{AB} ( {I}_{HDR} )}^{γ \frac{a}{a + b}} , & [ 1 ] \\ {I}_{B} = {{TM}_{AB} ( {I}_{HDR} )}^{γ} / {T}_{A} ( {I}_{A} ) , & [ 2 ]\end{matrix}$$

where the following notations are used: TM_{AB}: tone mapping operator (dynamic compression operator); T_{A}: linearized transfer function of the image display device A; a: bit depth of the image display device A; b: bit depth of the light projection unit B; and γ: gamma correction factor.

According to the invention, the first image I_{A} is displayed by means of an image display device A, for example a printer or electronic paper, and the second image I_{B} is projected onto the first image I_{A} by the light projection unit B. In this context, the image display device A is a device with an image quality that may be significantly lower in comparison to the light projection unit B with respect to tonal resolution, resolution, color space, banding effects, and dithering effects.

By means of the tone mapping operator TM_{AB}, the source image I_{HDR} is mapped onto a tonal resolution and a color scale of an overall image that is produced by the superimposition of the first image I_{A} on the second image I_{B}.

The first image I_{A} is derived for the image display device A with its bit depth a by means of Equation [1]. Artifacts (image errors) that arise in the displaying (screen display or printing) of the first image I_{A} are compensated with the second image I_{B}, which is generated according to Equation [2].

In Equation [2], T_{A} designates a linearized transfer function of the image display device A, which permits a simulation of the appearance of the first image I_{A} while taking into account the actual color space of the image display device A, the tonal resolution, and possible random artifacts that have resulted from banding or dithering.

Several splitting conventions that improve the image quality as a function of the capabilities of the display device A and the light projection unit B are described below.

In general it is advantageous to use a light projection unit B that can display a higher image quality than the image display device A. Specifically, this makes it possible to compensate artifacts in the first image I_{A} as efficiently as possible with the second image I_{B}.

When both the display device A and the light projection unit B can display colors, it is useful to carry out both the splitting of the source image I_{HDR} and the compensation of the artifacts in the RGB color space (color space with the primary colors red, green and blue), (and not in the luminance space followed by a recombination). In this way, clipping artifacts can be avoided during the compensation.

If the display device A (as the device with the lower quality) can only display gray levels, and the light projection unit B (as the device with the higher reproduction quality) can display colors, the splitting of the source image I_{HDR} is preferably carried out in the luminance space, while the compensation is performed in the RGB color space, in order to preserve the desired original colors and intensities. Details of the underlying relationships can be found in the aforementioned disclosure by SEETZEN et al. as well as in M. TRENTACOSTE et al., 2007, “Photometric image processing for high dynamic range displays,” J. Visual Communication and Image Representation 18, 5, pp. 439-451.

In the event that the display device A displays colors and the light projection unit B only gray levels, both the splitting and the compensation are carried out in the luminance space. The first image I_{A} is converted back to the RGB color space before it is displayed. In this case, only a luminance compensation is possible, while colors are approximated and chromatic aberrations remain uncompensated.

In the event that both the display device A and the light projection unit B display only gray levels, splitting and compensation are carried out in the luminance space.

For all of the aforementioned splitting techniques, the relevant transfer functions of the display device A and the light projection unit B must be linear. In addition to a linearization of a response function of the light projection unit B, this first requires knowledge of the overall transfer function (color and intensity) of the image display device A, so that these can be linearized through error correction. To this end, all possible color nuances and tonal values of the display device A are printed or displayed and are recorded through the camera 4 during a one-time calibration process of the illumination device 1. For example, for an 8-bit RGB photo printer, all 2²⁴ values can be spatially encoded and printed on four DIN A4 sized color cards. These color cards, which are recorded by a linearized high-resolution camera 4 under uniform white projector light, are rectified and indexed. Their entries are sampled, smoothed and stored in lookup tables. These lookup tables are inverted for linearization. Multiple entries are ascertained and missing values within the convex envelope of the sampled points are interpolated. Missing values outside the convex envelope are assigned their closest valid entries. It must be noted that these lookup tables only contain the color and intensity transfer to within a scale factor, while spatial transfer effects such as banding and dithering are preferably taken into account as well for the transfer function T_{A} in Equation [2]. These effects can be calculated based on known dithering and sampling functions instead of measuring them. For reasons of accuracy, the entire lookup tables are preferably stored and used, instead of separating individual color channels and employing them in a set of analytical functions, which would likewise be possible in the case of less stringent accuracy requirements.

A simplified version of the above-described first embodiment of the inventive method can be implemented in the event that the light projection unit B and the image display device A are both linear and have the same transfer characteristics (tonal resolution, resolution, color space, etc.). Then, the above-described complex HDR splitting of the source image I_{HDR} and the registration between the first image I_{A} and its hardcopy become unnecessary. In this case, the splitting of the source image is simplified in that the first image I_{A} is generated according to

I_{A}=\sqrt{(I_{HDR})^{γ}}. [3]

A high-resolution linear photograph thereof is projected back as the second image I_{B} without modification (aside from a possible, but constant, intensity scaling, which takes into account the f-stop settings of the camera 4). This produces acceptable results if the linearized camera response does not significantly reduce the image quality. In this embodiment, only a registration between the camera 4 and the light projection unit B is necessary. This embodiment even produces acceptable results if the transfer characteristics of the image display device A and the light projection unit B are not exactly the same, but are similar, and the image display device A has a better image quality than the light projection unit B. Image transfer effects (banding and dithering) are not compensated in this embodiment, however. The simplified embodiment can be used both for color images that are projected onto color hardcopies (“color on color”) and for the cases “gray on color” and “gray on gray.” It fails in the case of “color on gray,” however.

Luminance quantization: A variation of the above-described first embodiment of the invention takes into account luminance quantization with regard to the nonlinear reaction of the human visual system, and optimizes the images I_{A}, I_{B} while taking into account the discrete behavior of the image display device A and the light projection unit B.

The modulation resulting from the superimposition of the images I_{A}, I_{B} yields a large number of physically producible luminance levels. Because of the nonlinear behavior of the human visual system, however, not all producible luminance levels can be perceptually distinguished by an observer. The number of perceivable luminance levels (Just Noticeable Difference or JND steps), increases with increasing peak luminance of the display (in this regard, please see the paper by SEETZEN et al., which we have already cited multiple times). Since an exact display of the images with reliably distinguishable luminance levels is essential for many professional applications, such as many medical visualization techniques, images should preferably be converted into a JND space that is linear for perception rather than a luminance space that is physically linear.

GHOSH et al., 2005, “Volume rendering for high dynamic range displays,” Proc. EG/IEEE VGTC Workshop on Volume Graphics, pp. 91-231, describe a linear transfer function for volume rendering on HDR displays, for example. The technically achievable luminance space of such displays is discretized, however, and represents a challenge for quantization, since selected JND steps may not be exactly achievable under some circumstances because they cannot be associated with luminance levels that can be produced. This is especially the case when both modulators, thus the image display device A and light projection unit B here, are linearized independently of one another, resulting in a reduction of the tonal values per se in each individual channel, or else have a low local tonal resolution. On the other hand, many similar luminance levels can be approximated with more than one modulation combination. This leads to the question of how individual modulation combinations can be optimally mapped to selected JND steps, so that a maximum number of possible JND steps is achieved technically and the combination of the two modulators, which produces the selected JND steps, remains as monotonic as possible. The second condition is important in order to avoid visual artifacts in the case of minor registration error, significant difference in the modulator resolution, or inaccuracies arising in their measured transfer functions.

For the display of gray levels, this problem can be solved by sampling the reflected luminance values of all 2^{a} gray levels of the image display unit A (obtained from the above-described transfer lookup table), and all 2^{a} gray levels of the light projection unit B (obtained from a projection on a flat, white hardcopy). Multiplying them results in the corresponding luminance values of all 2^{a+b} gray level combinations. The normalized gray levels are assigned gray level coordinates x for the image display unit A and y for the light projection unit B (0≦x, y≦1). The goal is to achieve x=y^{σ} for a parameter a that is to be determined, with the following condition:

$$Max ( \vert {{⋃}^{n}}_{j = 0} \{ {s}_{j} \vert {min }_{{s}_{j} ∈ {C}_{j}} ( {L}_{{s}_{j}} - {L}_{j} ) \} \vert ) , \\ {C}_{j} = \{ c \vert {Δ}_{c} < Δ , {L}_{j} \leq {L}_{c} \vert \} . \qquad [ 4 ]$$

In Equation [4], j indexes individual JND steps (with respective luminance Lᵢ), which can be derived from a black level and a peak luminance that are each known after a calibration.

It is possible to apply, for example, a luminance quantization function that was described in R. MANTIUK et al., 2004, “Perception-motivated high dynamic range video encoding,” Proc. ACM Siggraph, vol. 23, pp. 733-741; 20, or R. MANTIUK et al., 2005, “Predicting visible differences in high dynamic range images-model and its calibration,” Proc. IS&T/SPIE's Annual Symposium on Electronic Imaging, vol. 5666, pp. 204-214, since it is defined for the luminance range required here. In this regard, L₀ is equivalent to the lowest black level reflection of the light projection unit B. For every (theoretically) possible JND step j, a set Cⱼ of gray level candidates cεCⱼ is selected that results in reproducible luminance levels L_{c} that are greater than or equal to the luminance Lⱼ of the JND step j and whose shortest x,y distances Δ_{c} to the function x=y^{σ} are no greater than a predefinable maximum distance Δ. From every set Cⱼ, the candidate sⱼεC₃ that best approximates Lⱼ is chosen.

Setting x=y^{σ} with the maximization of the number of technically possible JND steps results in an optimal set of gray levels of the image display device A and the light projection unit B for every JND step that fulfills the desired condition. These are the gray levels that belong to the selected candidates sⱼεCⱼ of the JND steps at the optimal value of the parameter σ.

In order to display colored content, the luminance of the original RGB values is scaled with the applicable (normalized) gray levels that were selected for the image display device A and the light projection unit B.

Inverse tone mapping: In the second embodiment of the inventive method, the image data record which is used to derive the modulated illumination of the object 8 is produced from a camera image of the object 8 recorded with the camera 4, and an illumination data record for controlling the light projection unit is created from the image data record.

In this process, an intermediate image with an increased contrast ratio relative to the camera image is preferably generated first, and the illumination data record is then created from the intermediate image. An inverse tone mapping operator that was described in the aforementioned disclosure by BANTERLE et al. can be used, for example.

As already mentioned, in this case the intermediate image takes over the role of the source image I_{HDR}, and the illumination data record takes over the role of the second image I_{B} of the first embodiment, in the sense that an HDR-like image is created by means of the inverse tone mapping, and the illumination data record is generated from the intermediate image and is used for controlling the light projection unit B.

In this case, the object 8 can be an LDR image, for example a normal photograph, or another, in particular three-dimensional, object, for example an object to be reproduced by means of an optical instrument.

To generate the intermediate image, the object 8 is recorded by the camera 4 under illumination with light having at least one predefinable reference illumination characteristic, and reflection values of light reflected from the object under this illumination are recorded. In this regard, a maximum and a minimum brightness setting of the light projection unit B and/or a specific illumination pattern, for example, are chosen as reference illumination characteristics. A maximum local reflection value Iₘₐₓ and a minimum local reflection Iₘᵢₙ are derived from the recorded reflection values for each pixel of the camera images, and the derived maximum and minimum local reflections Iₘₐₓ, Iₘᵢₙ are converted into local luminance values Lₘₐₓ Lₘᵢₙ, from which a global luminance maximum L̅ₘ̅ₐ̅ₓ̅ and a global luminance minimum L̅ₘ̅ᵢ̅ₙ̅ are derived. The input quantities for the inverse tone mapping are derived from these values.

An alternative to the use of inverse tone mapping arises from the fact that, in terms of perception, simple scaling transformations produce results similar to those that sophisticated tone mapping operations can achieve, and sometimes even exceed them. A scaling transformation that can be adapted for the application of the inventive method was described in A. AKYÜZ et al., 2007, “Do hdr displays support Idr content?: a psychophysical evaluation,” Proc. ACM Siggraph, vol. 26, pp. 38.2-38.7.

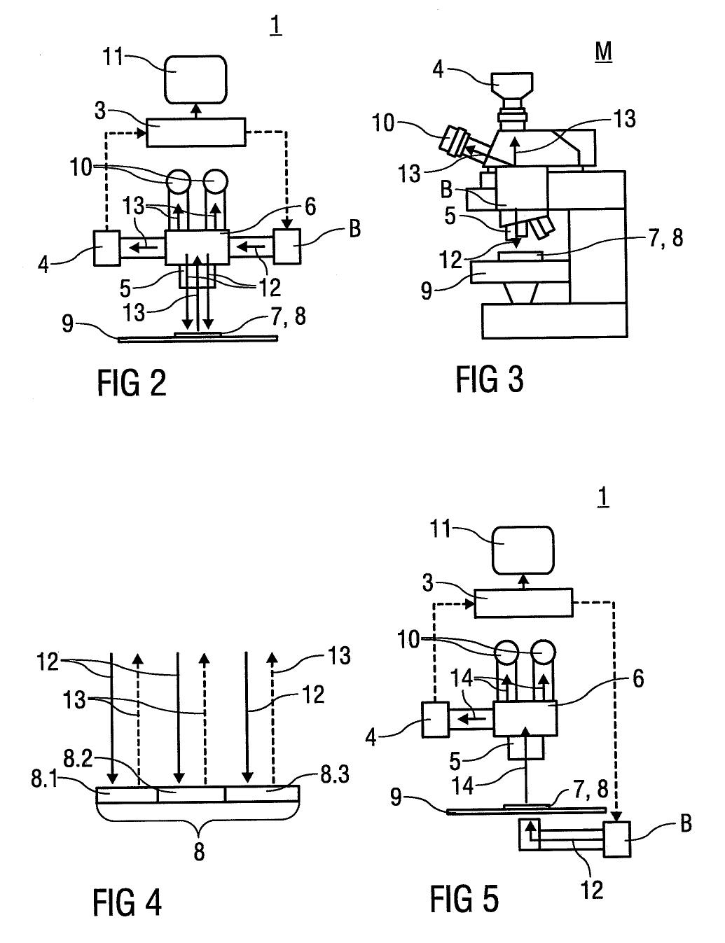

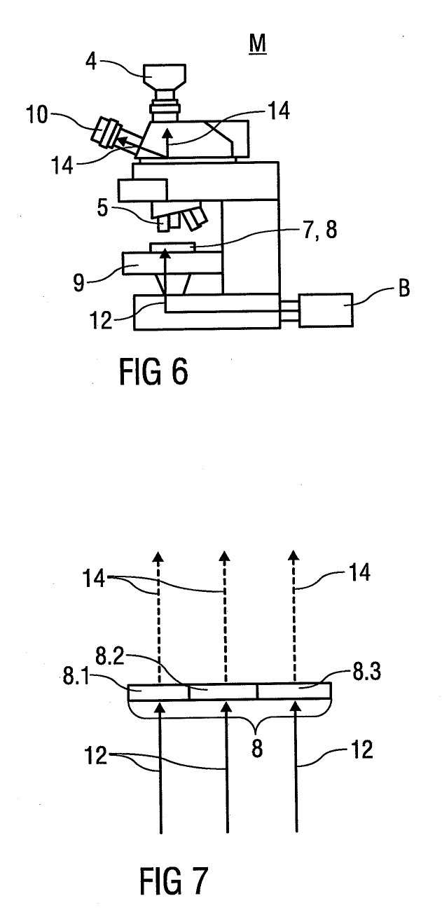

FIGS. 2 to 7 show applications of inventive illumination devices 1 and the inventive method in its second embodiment for contrast-enhancing illumination of an object 8 in an optical microscope M. These example embodiments of the invention can be adapted to other optical instruments, for example endoscopes, in an obvious manner.

FIG. 2 schematically shows an inventive illumination device 1 for an optical microscope M for incident light microscopy.

FIG. 3 shows an optical microscope M with an illumination device 1 of this type for incident light microscopy.

The illumination device 1 in turn has a digital light projection unit B, a control unit 3 and a digital camera 4.

An illumination characteristic of the light projection unit B can be spatially and temporally modulated by the control unit 3, so that an intensity distribution of the light 12 emitted by the light projection unit B can be spatially and temporally altered by means of the control unit 3.

The light projection unit B is located in the optical microscope M above microscope objectives 5, any selected one of which can be directed at an object 8 that is to be microscopically examined and is arranged on a specimen stage 9 of the optical microscope M by means of a specimen slide.

The light projection unit B is preferably adjusted such that light 12 emitted from it is initially focused at infinity upon leaving the light projection unit B, for example by directing the light 12 emitted therefrom into a so-called infinite beam path of the optical microscope M. By this means, focusing of the object 8 in a particular case requires only changing the focus of the microscope M by selecting and adjusting a microscope objective 5, without the need to refocus the light projection unit B or the camera 4.

The light 12 emitted by the light projection unit B is directed by an optical unit 6 of the optical microscope M onto the object 8 that is to be microscopically examined. Light 13 reflected by the object 8 that passes through the selected microscope objective 5 is split between oculars 10 of the optical microscope M and the camera 4 and is directed to both by the optical unit 6. The camera 4 is mounted on an upper camera connection of the optical microscope M.

The camera 4 acquires image data of the object 8 through the portion of the reflected light 13 directed to it. These image data are fed to the control unit 3. The control unit 3 detects local contrasts of these image data, and derives from them an illumination data record for regulating the illumination characteristics of the light projection unit B.

During this process, in areas where the detected local contrasts of the image data are low, the intensity of the light 12 emitted by the light projection unit B is changed in such a manner that the change in intensity counteracts the deviation of the local contrasts from the target contrast values.

A preferred embodiment of the inventive method provides real-time regulation of the illumination characteristics of the light projection unit B. To this end, the camera 4 is continuously synchronized with the light projection unit B by means of the control unit 3. Real-time regulation is advantageous, in particular, when the object 8 that is to be microscopically examined can move and/or change shape, since in this way the instantaneous position and/or shape of the object 8 can be taken into account for contrast regulation.

In another embodiment of this example embodiment, the image data acquired by the camera 4, following an image processing performed by the control unit 3 if applicable, are also delivered to a monitor 11 and output thereby. Alternatively or in addition, additional information derived from the image data by the control unit 3 and/or delivered to the control unit 3, for example an expansion or speed of the object 8, is displayed on the monitor 11 and/or is projected onto the object and/or in its surroundings by means of the light projection unit B.

FIG. 4 schematically shows a spatially modulated incident illumination by light 12 emitted by the light projection unit B of an object 8 that is to be microscopically examined. Shown are three areas 8.1, 8.2, 8.3 of the object 8, each with different optical properties. Through regulation of the illumination characteristics of the light projection unit B by means of the control unit 3, the three areas 8.1, 8.2, 8.3 are illuminated with light 12 from the light projection unit B having different intensity in each case, so that a significantly higher contrast is achieved as compared with uniform illumination of the areas 8.1, 8.2, 8.3.

FIGS. 5 to 7 correspond to FIGS. 2 to 4, respectively. In contrast to the arrangement shown in FIGS. 2 to 4, the illumination device 1 in this example is provided for transmitted light microscopy. To this end, the light projection unit B is located below the specimen stage 9 of the optical microscope M, for example at a connection that is typically provided for a high-pressure mercury vapor lamp for fluorescence microscopy. The object 8 that is to be microscopically examined is illuminated from below with light 12 emitted by the light projection unit B. In this case, instead of light 13 reflected from the object 8, light 14 transmitted through the object 8 is delivered to the camera 4 and the oculars 10 of the optical microscope M.

The example embodiments described above with the aid of FIGS. 2 to 7 can be further developed in a variety of ways. For example, the object 8 can be illuminated in parallel or sequentially by multiple light projection units B, in particular through different inputs of the optical microscope M, with the respective illuminations being spatially modulated or homogeneous.

In particular, in this way the object 8 can use light with different spectral distributions sequentially or in parallel, for example light in the infrared, ultraviolet, and/or visible range.

Alternatively or in addition, different spectral components of the light 13 reflected from the object 8 and/or the light 14 transmitted through the object 8 can be acquired, for example through different microscope outputs, by multiple cameras 14 that are each equipped with different bandpass filters. These spectral components can then be combined in a variety of ways and analyzed for inventive contrast-enhancing illumination of the object 8.

For example, the object 8 can be illuminated in a spatially modulated or homogeneous manner with infrared (IR) and/or ultraviolet (UV) light from a first light projection unit B. This light is modulated in the object 8 and is recorded by at least one camera 14 as IR and/or UV light 13 reflected from the object 8, and/or as IR and/or UV light 14 transmitted through the object 8. Using the acquired image data, a second light projection unit B is regulated by the control unit 3, by which means the object 8 is illuminated in a contrast-enhancing manner with visible light through a second microscope input.

In this way, the actual illumination of the object 8 can differ from an illumination that is visually perceptible through an ocular 10 of the optical microscope M. For example, the object 8 can be continuously illuminated in a homogeneous manner with IR and/or UV light, while an observer sees a contrast-enhancing visible illumination through the ocular 10. This contrast-enhancing illumination does not affect the IR and/or UV camera pictures from which the contrast-enhancing visible illumination is calculated in each case for a later point in time. Thus, the object 8 can also be moved, for example, without causing interactions between the IR and/or UV camera pictures at a first point in time and a modulated contrast-enhancing illumination with visible light at a second, later point in time.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for optical contrast enhancement of an object by a spatially and/or temporally modulated illumination of the object via at least one light projection unit, the method comprising:
determining the spatial and/or temporal modulation of the illumination of the object based on an image data record associated with the object, the object being a first image derived from a source image and displayed using an image display device;
deriving a second image from the source image, the second image being used as an image data record; and
projecting congruently the second image onto the first image,
wherein the first and second images each have a contrast range that is lower than the source image and lower than an overall image resulting from the projection of the second image onto the first image.

2. The method according to claim 1, wherein the second image is formed as a function of a linearized transfer function of the image display device.

3. The method according to claim 1, wherein the images are derived from the source image in accordance with the following calculation rules:
$$\begin{matrix}{I}_{A} = {{TM}_{AB} ( {I}_{HDR} )}^{γ \frac{a}{a + b}} , \\ {I}_{B} = {{TM}_{AB} ( {I}_{HDR} )}^{γ} / {T}_{A} ( {I}_{A} ) ,\end{matrix}$$
wherein:
TM_{AB}: is a tone mapping operator;
T_{A}: is a linearized transfer function of the image display device (A);
a: is a bit depth of the image display device (A);
b: is a bit depth of the at least one light projection unit (B);
γ: is a gamma correction factor.

4. The method according to claim 1, wherein the first and second images are derived from the source image such that:
image errors that arise in the first image are at least partly compensated by the projection of the second image onto the first image;
the compensation of the image errors in the first image and the derivation of the images take place exclusively in the RGB color space if both images are displayed as color images;
the images are derived exclusively in a luminance space, and compensation of the image errors in the first image takes place in the RGB color space if the first image is displayed as a gray-level image and the second image is displayed as a color image;
the compensation of the image errors in the first image and the derivation of the images take place in the luminance space, with the first image being converted back to the RGB color space before it is displayed, if the first image is displayed as a color image and the second image is displayed as a gray-level image; and/or
the compensation of the image errors in the first image and the derivation of the partial data records take place in the luminance space if both images are displayed as gray-level images.

5. A method for optical contrast enhancement of an object by a spatially and/or temporally modulated illumination of the object by at least one light projection unit, the method comprising:
determining a spatial and/or temporal modulation of the illumination of the object based on an image data record associated with the object that is produced from a camera image of the object recorded by a camera; and
generating from the image data record an illumination data record for controlling the at least one light projection unit.

6. The method according to claim 5, wherein an intermediate image with an increased contrast ratio as compared to the camera image is produced from the image data record by inverse tone mapping, and wherein the illumination data record is generated from the intermediate image.

7. The method according to claim 5, wherein, in order to generate the intermediate image, the steps are performed:
photographically recording of the object under illumination of the object with light having at least one predefinable reference illumination characteristic by the at least one light projection unit and recording of reflection values of light reflected from the object under this illumination;
deriving a maximum local reflection value and a minimum local reflection at different points of the camera images;
converting the maximum local reflections and minimum local reflections into local luminance values; and
determining a global maximum and a global minimum of the derived luminance values.

8. The method according to claim 5, wherein local contrast values are derived from the image data record and contrasts are locally increased in areas of the object recognized as low-contrast by regulating the illumination characteristics of the at least one light projection unit using the illumination data record.

9. The method according to claim 5, wherein image parameters are derived from the image data record for the detection of highlights produced by light reflections at the object and detected highlights are counteracted by the regulation of the illumination characteristics of the at least one light projection unit.

10. The method according to claim 5, wherein image parameters for the detection of scatterings of the light emitted by the at least one light projection unit are determined within the object, and wherein detected scatterings are counteracted by the regulation of the illumination characteristics of the at least one light projection unit.

11. The method according to claim 5, wherein the camera is arranged in a beam path of the light emitted by the at least one light projection unit such that said camera receives light reflected by the object.

12. The method according to claim 5, wherein the camera is arranged in a beam path of the light emitted by the at least one light projection unit in such a manner that said camera receives light transmitted through the object.

13. The method according to claim 5, wherein, as illumination data record, a second image of the object is derived, and the second image is projected congruently onto the object.

14. An illumination device for optical contrast enhancement of an object, the device comprising:
at least one light projection unit whose illumination characteristics are configured to be modulated spatially and/or temporally;
a control unit configured to modulate the illumination characteristics of the at least one light projection unit based on an image data record associated with the object; and
a camera coupled to the control unit, the camera recording a camera image of the object to create the image data record.

15. The illumination device according to claim 14, wherein the camera is arranged in a beam path of the light emitted by the at least one light projection unit such that said camera receives light reflected by the object.

16. The illumination device according to claim 14, wherein the camera is arranged in a beam path of the light emitted by the at least one light projection unit in such a manner that said camera receives light transmitted through the object.

17. The illumination device according to claim 14, wherein the illumination device is an illumination device in an optical instrument for contrast-enhancing illumination of an object to be reproduced with the optical instrument.

18. The illumination device according to claim 17, wherein the optical instrument is an optical microscope or endoscope.
